(19) United States
(12) Patent Application Publication
(10) Pub. No.: US 2011/0172881 A1
(43) Pub. Date: Jul. 14, 2011

(54) METHOD FOR STABILIZING VEHICLE MOTIONS OF A SINGLE-TRACK MOTOR VEHICLE, USING THE ANGLE OF INCLINATION AND THE ATTITUDE ANGLE, AS WELL AS A DEVICE FOR SAME

(76) Inventors: Juergen Seidel, Esslingen (DE); Frank Niewels, Ludwigsburg (DE); Christian Waldschmidt, Stuttgart (DE); Matthias Moerbe, Ilsfeld-Helfenberg (DE); Peter Ziegler, Grossbottwar (DE); Stephan Hoenle, Korntal-Muenchingen (DE)

(21) Appl. No.: 12/736,854

(22) PCT Filed: Dec. 19, 2008
(86) PCT No.: PCT/EP2008/067964

§ 371 Date: Mar. 3, 2011

(30) Foreign Application Priority Data
May 26, 2008 (DE) 10 2008 001 970.4

(51) Int. Cl. B60G 17/00; G06F 19/00

(52) U.S. Cl. 701/37; 701/36

(57) ABSTRACT

In a method for stabilizing a vehicle motion of a single-track motor vehicle, e.g., a motorcycle, an angle of inclination of the motor vehicle relative to the roadway is recorded via inclination sensors and, after the processing of the angle of inclination in a computing device, a control signal based on this is supplied to a control device for bringing about a stabilization intervention in the vehicle motion, the attitude angle of the motor vehicle being recorded and jointly processed in the control device, using at least one attitude angle recording sensor.

### BACKGROUND OF THE INVENTION

1. Field of the Invention

The present invention relates to a method for stabilizing vehicle motions of a single-track motor vehicle, such as of a motorcycle, in which an angle of inclination of the motor vehicle relative to the roadway is recorded via inclination sensors and, after processing of the angle of inclination in a computing device, a control signal based on this is supplied to a control device, for bringing about a stabilization intervention in the vehicle motion.

2. Description of Related Art

By attitude angle one should understand the rotational angle of the entire vehicle with respect to the direction of motion. This attitude angle occurs during cornering and particularly during drifting.

By contrast, a tire slip angle is understood to mean the angle that is present between the direction in which a wheel is pointing and the direction in which the wheel is actually moving in the lane. The tire slip angle is the angle between a line of intersection, a wheel center plane and a roadway plane on the one hand, and a projection of the speed vector of a wheel center onto the roadway, on the other hand.

The tire slip angles at the wheels may be different from the attitude angle of the whole vehicle.

A device for determining the pitch angles and the roll angles in motor vehicles is known from the related art, such as from published German patent document DE 4117540 A1. A pitch angle and a roll angle as well as the height above the roadway, as seen from the bottom of the vehicle, are determined via three ultrasound sensors, in this context. The three ultrasound sensors are situated in such a way that they span a plane between themselves.

German Laid-Open patent application Document DE 10238526 A1 describes a method and a device for the detection of inclination. The document describes ultrasound sensors, lidar sensors and radar sensors as suitable for ascertaining the inclination of single-track motor vehicles.

However, it has been shown in the past that, in the case of a single-track motor vehicle, such as a motorcycle, the sole measurement of the vehicle position with respect to the roadway is often not sufficient adequately to stabilize this vehicle even in difficult driving maneuvers. Particularly in the case of accelerating from curves, there is the danger that too great a tire slip angle may lead to a fall. The tire slip angle is also designated as drift angle in the literature.

Situations that are especially critical arise if large tire slip angles are present at the rear wheel. The cause for this may be found in two cases, namely for one, that the rear wheel “skids” in response to too great a tire slip angle, and consequently the vehicle falls to the center of the curve, and secondly, if the “skidding rear wheel” finds higher coefficients of friction again on a different section of the roadway, and thus “grips onto the roadway” again, whereby the vehicle stands up in a jerk and falls out of the curve.

So-called load alteration processes are also particularly critical, caused by the change in the throttle twist grip because of engaging or disengaging the clutch and/or because of braking.

A fall of the motor vehicle, that is, of the two wheeler, such as a motorcycle, is not only dangerous for the user of this vehicle but also endangers third parties that were non-participating up until then. Such falls must therefore be avoided.

### BRIEF SUMMARY OF THE INVENTION

The present invention is characterized in that the attitude angle of the motor vehicle is recorded, using at least one attitude angle detecting sensor, and is jointly processed in the control device.

The present invention also relates to a device having corresponding means for carrying out the method according to the present invention.

An unfavorable development for the driving dynamics situation may be detected early in this manner, and the vehicle may be stabilized again. The tire slip angle at each of the wheels may be limited to a safe extent in this way. The handling properties of the single-track motor vehicle become better manageable and falls are prevented even in difficult and demanding situations. This makes possible an earlier and more measured control and/or regulation of the motor vehicle.

Thus, it is particularly advantageous if the speed of the motor vehicle is recorded and is processed jointly in the computing device. The stabilization interventions may then be triggered as a function of the respectively present speed or the respectively existing acceleration. A more sensitive response of the control and regulating devices, which lead to a driving dynamics change of the motor vehicle are made possible thereby.

If the curve over time of the attitude angle is recorded and processed jointly in the computing device, it is possible, even earlier, in particular before the occurrence of critical driving dynamics situations, to execute stabilization interventions in a controlling or regulating manner.

In order to stabilize the vehicle efficiently, it is advantageous in one additional exemplary embodiment if the control signal gives rise to disengaging the clutch, making a braking intervention, reducing the engine's drive torque and/or to an active suspension control. When the different stabilization interventions are combined, the effect is more rapid stabilization and greater precision when aligning the motor vehicle so as to avoid a crash.

In order not to base the stabilization method only on the attitude angle of the overall vehicle, it is to be recommended, in an additional advantageous embodiment variant, if an attitude angle recording sensor ascertains the tire slip angle at one wheel of the motor vehicle, preferably at the rear wheel, and this is jointly processed in the computing device. Thus, the attitude angle recording sensor is in a position not only to record the attitude angle and to transmit it on, but also to take into account the tire slip angle of at least one wheel, so that the control signal is able to be generated in the computing device of the post-connected control device.

If the attitude angle recording sensor is a radar sensor, the freedom of design is clearly increased, since besides ultrasound sensors, infrared sensors and lidar sensors (“light detection and ranging sensors”) particularly robust radar sensors may also be used. In making contactless measurements, radar sensors have the advantage that they are independent of mechanical stresses, are easy to mount and work in an essentially maintenance-free manner, even during poor visibility conditions.

In situations judged to be critical, in order to give rise to the triggering of the control signal in a reliable way, it is advantageous if the control device triggers the control signal after a boundary value is exceeded.

In order to be able to capture the same situations for every vehicle, it is advantageous if the boundary value is preset in a fixed manner. On the one hand, this may be done at the factory, that for all vehicles of the same type the same triggering characteristics are at hand, or are able to be set by each operator individually, so as to take into consideration the respective driving style of the respective operator.

The present invention also relates to a device which has corresponding means for carrying out such a method, and which is designed in a particularly advantageous manner when this device is able to be retrofitted in existing single-track motor vehicles.

### BRIEF DESCRIPTION OF THE SEVERAL VIEWS OF THE DRAWINGS

FIG. 1 shows a schematic representation of a motorcycle during cornering, having two inclination sensors and two pitch sensors.

FIG. 2 shows a schematic representation of the arrangement of the inclination sensors and the pitch sensors from FIG. 1, along with the area on the roadway surface swept by the sensors.

FIG. 3 shows an enlarged representation of the region of the motorcycle at which the inclination sensors and the pitch sensors are applied, as well as the area swept by the sensors.

FIG. 4 shows a schematic representation of the “pitching” of a motor vehicle during a braking maneuver.

FIG. 5 shows a schematic representation of the sequence of the method in a flow chart.

### DETAILED DESCRIPTION OF THE INVENTION

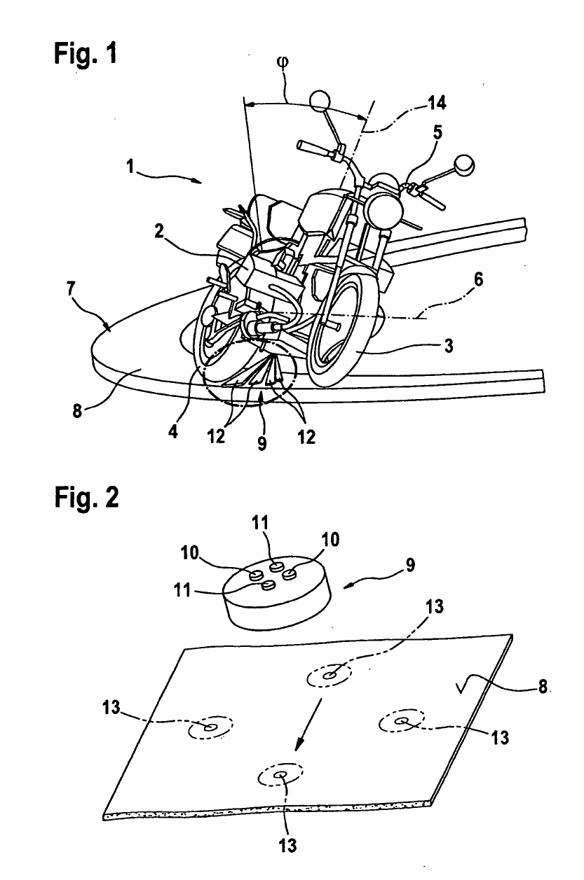

FIG. 1 shows a single-track motor vehicle 1. In the exemplary embodiment shown, the single-track motor vehicle is a motorcycle. The motorcycle has an internal combustion engine 2, a front wheel 3 and a rear wheel 4. Front wheel 3 is able to be deflected relative to a longitudinal axis 6, using a handlebar 5. Motor vehicle 1 moves in a curve 7 on a roadway 8. Between rear wheel 4 and front wheel 3, a sensing device 9 is mounted in the lower region of the motorcycle. Sensing device 9 includes two inclination sensors 10. Sensing device 9 also includes two pitch sensors 11. Inclination sensors 10 and pitch sensors 11 are recognizable particularly well in FIG. 2.

Sensor device 9 is developed as a radar-based speed vector sensor device and has four so-called antenna lobes 12. In each case two antenna lobes 12 are produced by the two inclination sensors 10. The other two antenna lobes 12 are produced by pitch sensors 11.

Using sensing device 9, a measurement is undertaken of the distance of sensing device 9 from the surface of roadway 8 in four directions, that is, in the direction of travel and transversely to the direction of travel.

Two contact patches 13 of antenna lobes 12 formed by inclination sensors 10 are aligned so that a connecting line through these contact patches is aligned orthogonally to the longitudinal direction of the vehicle. These two antenna lobes 12, which are produced by pitch sensors 11, are aligned in the longitudinal direction of the vehicle, that is, along longitudinal axis 6. A straight line through contact patches of antenna lobes 12, that are given rise to by pitch sensors 11 with respect to the surface of the roadway, is orthogonal to a straight line through the contact patches of antenna lobes 12, as given rise to by inclination sensors 10, with respect to the surface of roadway 8.

The special arrangement of inclination sensors 10 and pitch sensors 11 may be seen in FIG. 2. In this context, arrow 13 designates the direction of travel of motor vehicle 1 which, in the exemplary embodiment shown in FIG. 2, corresponds to the same as longitudinal axis 6 of the motor vehicle. Sensing device 9 is shown in FIG. 2 detached from the remaining motorcycle. Antenna lobes 12 are not shown. However, the contact patches of antenna lobes 12 are shown on the surface of roadway 8, and provided with reference numerals 13.

Getting back to FIG. 1, motor vehicle 1 is shown there inclined, traveling in curve 7, so that there exists an angle φ between a vertical axis and a vertical vehicle axis 14 through motor vehicle 1. Angle δ is normally less than 50°-60°, as a rule 56°. It is true that the exemplary embodiment according to FIG. 1 shows a horizontal roadway surface of roadway 8, but it is possible that the curve is banked, and consequently it is not the angle to the roadway surface that remains relevant, but rather the angle to the horizontal.

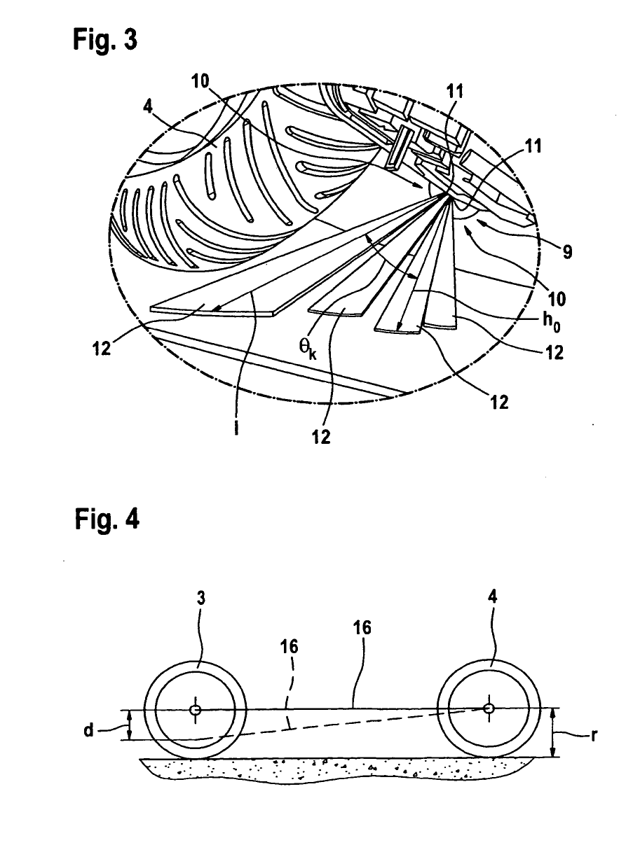

As may be easily seen in FIG. 3, one of inclination sensors 10 measures length l. The pitch sensors determine the height recalculated to height h₀ via an appropriate algorithm.

Furthermore, in a computing device 15, which is not shown in the figures up to 4, an angle Θₖ is ascertained. In computing device 15, angle φ is determined using a subsequent algorithm.

$$ϕ = ℜ \{ log ( \frac{1 \cdot exp ( j {Θ}_{k} ) - {h}_{0}}{{h}_{0} - 1 \cdot exp ( - j {Θ}_{k} )} ) \vert 2 \cdot j \}$$

In this way, the inclination angle is determined with the aid of measured length l, that is, the distance between one of inclination sensors 10 and the surface of roadway 8, the example being shown being that a right antenna lobe 12, as seen in the direction of travel, forms the basis. However, left antenna lobe 12, as seen in the direction of travel, may also form the basis.

Since it is also an aim of the present invention to have available the knowledge of the contact pressure and the contact conditions in every driving situation, that is, also during braking processes that cause “pitching”, and in curves, the effect of braking while causing “pitching” is shown in FIG. 4. In this context, the motor vehicle dips into the wheel suspension situated at front wheel 3, whereby the vehicle sinks down by a quantity d in the region of front wheel 3. The position of an elongated frame element 16 that is assumed after and during braking is shown by a dashed line. As a rule, distance d is less than radius r.

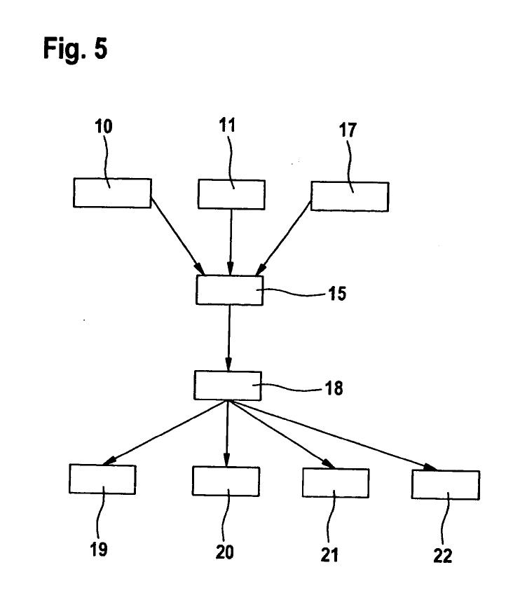

FIG. 5 shows a flow chart for a method according to the present invention. Inclination sensors 10 and pitch sensors 11 supply data to computing device 15. In order to increase the control quality and the regulating quality, at least one attitude angle recording sensor 17 additionally supplies data to computing device 15. The attitude angle recording sensor 17 value supplies the attitude angle, in this instance, but it is also in a position to deliver either the tire slip angle of the rear wheel and/or the tire slip angle of the front wheel to computing device 15. Thus, in attitude angle recording sensor 17 a preprocessing of the raw data takes place. The preprocessing of the raw data may also take place, however, in computing device 15. It is possible for attitude angle recording sensor 17 to be a part of the sensing device, which includes inclination sensors 10 and pitch sensors 11. A corresponding calculated solution is then necessary for calculating from this the attitude angle.

Computing device 15 supplies a signal to control device 18. This signal is a control signal, which is generated by computing device 15 in processing the data supplied. Control device 18 now acts on one or more of the control devices and regulating devices, such as a clutching device 19, a braking device 20, an active suspension control device 21 and a speed regulating device 22. By appropriate brief disengaging of the engine, short-term braking, softer or harder setting of the suspension and/or supplying or reducing gas, the vehicle is then stabilized again.

According to the present invention, no longer are only the inclination angle and the pitch angle used for giving rise to previously stabilizing braking interventions and steering interventions, but rather the attitude angle and/or the tire slip angle. Because of that, the vehicle is stabilized again, earlier and more securely, by appropriate stabilization interventions with respect to the driving dynamics response. Falls of such single-track motor vehicles 1 and especially of operator of such single-track motor vehicles 1 are effectively prevented.

The traffic safety of a corresponding single-track motor vehicles, such as a motorcycle, is increased by this.

1-9. (canceled)

10. A method for stabilizing a vehicle motion of a single-track motor vehicle, comprising:
recording, using at least one inclination sensor, an angle of inclination of the motor vehicle relative to a roadway;
recording, using at least one attitude angle recording sensor, an attitude angle of the motor vehicle;
jointly processing the angle of inclination information and the attitude angle information in a computing device to generate a control signal; and
supplying the control signal to a control device to implement a stabilization intervention in the vehicle motion of the motor vehicle.

11. The method as recited in claim 10, further comprising:
recording the speed of the motor vehicle, wherein the recorded speed is jointly processed in the computing unit along with the angle of inclination information and the attitude angle information.

12. The method as recited in claim 11, wherein a time curve of the attitude angle is recorded and is jointly processed in the computing unit along with the angle of inclination information and the attitude angle information.

13. The method as recited in claim 11, wherein the control signal implements at least one of: a disengagement of the engine; a braking intervention; an engine drive torque reduction; and an active suspension control.

14. The method as recited in claim 11, wherein the attitude angle recording sensor ascertains a tire slip angle at one wheel of the motor vehicle, and wherein the tire slip angle is jointly processed in the computing device along with the angle of inclination information and the attitude angle information.

15. The method as recited in claim 13, wherein the attitude angle recording sensor is a radar sensor.

16. The method as recited in claim 13, wherein the control device implements the stabilization intervention based on the control signal only if a boundary value is exceeded.

17. The method as recited in claim 16, wherein the boundary value is preset in a fixed manner.

18. A device for stabilizing a vehicle motion of a single-track motor vehicle, comprising:
at least one inclination sensor for recording an angle of inclination of the motor vehicle relative to a roadway;
at least one attitude angle recording sensor for recording an attitude angle of the motor vehicle;
a computing device for jointly processing the angle of inclination information and the attitude angle information to generate a control signal; and
a control device receiving the control signal from the computing device and implementing a stabilization intervention in the vehicle motion of the motor vehicle based on the control signal.
